(19) United States
(12) Patent Application Publication
(10) Pub. No.: US 2009/0178467 A1
(43) Pub. Date: Jul. 16, 2009

(54) MULTI-PURPOSE CONCENTRATION SENSORS AND TEST METHODS

(76) Inventors: Hongtan Liu, Miami, FL (US); Jiahua Han, Grayslake, IL (US)

Correspondence Address: NIXON & VANDERHYE, PC, 901 NORTH GLEBE ROAD, 11TH FLOOR, ARLINGTON, VA, 22203, US

(21) Appl. No.: 12/305,296

(22) PCT Filed: Jun. 21, 2007
(86) PCT No.: PCT/US07/14503

§ 371 Date: Dec. 17, 2008

Related U.S. Application Data
(60) Provisional application No. 60/815,267, filed on Jun. 21, 2006.

(51) Int. Cl. G01N 25/00

(52) U.S. Cl. 73/25.01

(57) ABSTRACT

A multi-purpose concentration sensor (MPCS) for organic compounds/gases or other compounds/gases tests the concentration of target content of the compound/gas such as methanol dissolved in certain solvents like water, where the exemplary methanol solution is called target solution, where the sensor can optionally or alternatively test the concentration of gas state target content like methanol vapor in a gas mixture and where the gas mixture to be tested is called target gas. The MPCS comprises two chambers or flow passages, a ‘separate’ structure, one or more diffusion or transport structures, one or more transfer structures, optionally includes one or more temperature control structures, one or more aim sensors, and optionally, one or more thermal management structures.

### RELATED APPLICATION

This application claims priority from and is based upon U.S. Provisional Patent Application Ser. No. 60/815,267, filed on Jun. 21, 2006, the entire content of which is hereby incorporated by reference.

### FIELD AND BACKGROUND OF THE INVENTION

The present invention relates to multi-purpose concentration sensors, which can be used with organic compounds. For example, methanol can be obtained from biomass, and it is regarded as an important type of renewable resource. Concentration testing of methanol solutions is very important for a direct methanol fuel cell device and working environment detection because of their dangerous properties. However, the known concentration testing of methanol solutions is not an easy procedure.

Besides methanol, the concentration of many similar chemical products is very difficult to test and usually time consuming and economically costly. A multi-purpose high-precision sensor has been invented and has been experimentally tested on methanol solutions having concentrations from 0.5M to 5M with high precision, low cost and speed. The same device can be used to test other chemical products with little or no change in structure.

### BRIEF DESCRIPTION OF THE DRAWINGS

FIG. 1 is an embodiment of a multi-purpose, high-precision sensor according to the present invention.

FIG. 2 is an embodiment of a multi-purpose, high-precision sensor for a methanol concentration test according to the present invention.

### SUMMARY AND DETAILED DESCRIPTION OF THE INVENTION

Methanol and its derivatives are widely used and employed in the chemical, drug, food, and perfume industries. They are also regarded as a promising type of energy resource, e.g., as a substitute for fossil-based energy resources.

In a direct methanol fuel cell (DMFC), low concentration methanol solution is used as the fuel, and it is superior to hydrogen in both energy density and availability. Whether for a methanol related industrial production procedure or for a DMFC device, determining the methanol concentration is very important. However, methanol can be dissolved in water to any degree, is colorless, and has a similar density. As a result, it is very difficult, using known methods, to test/determine the concentration of a methanol solution, and it also is time consuming and economically costly.

The present invention comprises a new type of multi-purpose high-precision sensor. Its inventive working principle is based on the concept that something which is hard to be detected, like methanol, can be detected by transferring it into something which is easy to be detected with high precision, like carbon dioxide.

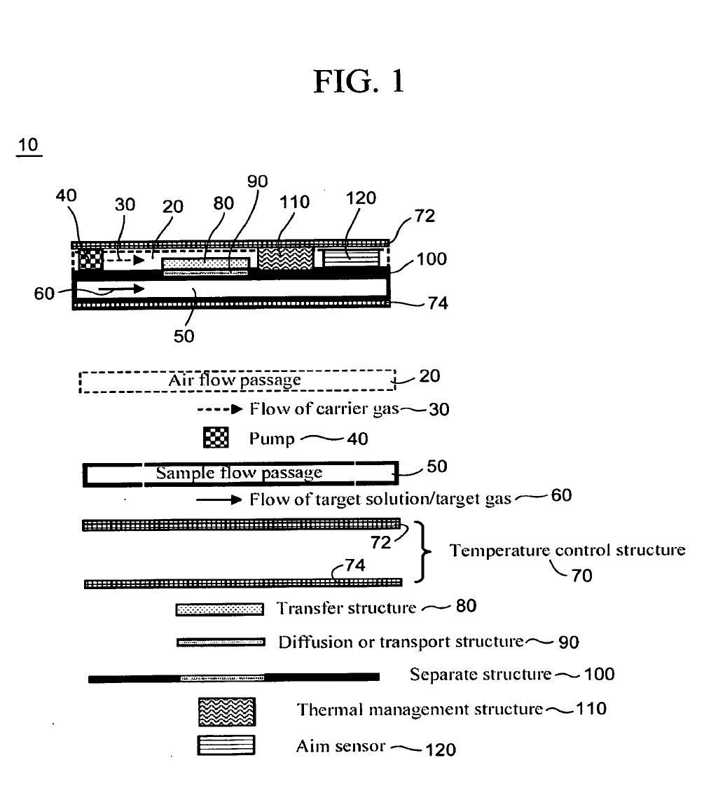

FIG. 1 shows one embodiment of a general purpose/multi-purpose high-precision sensor 10 according to the present invention. As shown in FIG. 1, a multi-purpose high precision sensor 10 is designed for testing the concentration of target content (TC) such as methanol dissolved in a solvent such as water. The methanol solution is called the target solution. It is also able to test the concentration of gas state target content such as methanol vapor in a gas mixture. The gas mixture to be tested is called target gas.

The sensor comprises:

a) Two chambers or flow passages 20 and 50. One of the chambers/flow passages is for air/oxygen or other carrier gases (CG) to flow through, named air flow passage 20. The other one is for the target solution or the target gas to flow through or just to store the target solution or target gas inside, named sample flow passage 50. The target solution or target gas is fed by a passive method or through an electric-driven device like a pump etc. The carrier gas is fed by an active method such as a pump, air blower etc. or directly from a high-pressure gas source like a gas tank to provide the flow of carrier gas 30. Other standard devices may be used for a constant flow rate of the carrier gas.

b) One “separate” structure 100. The separate structure 100 is set between the sample flow passage 50 and the air flow passage 20 to “separate” the two passages.

c) One or more diffusion or transport structures 90. The diffusion or transport structures 90 consist of part or all of the separate structure 100, through which the target content in the sample flow passage 50 is able to diffuse or just flow to the air flow passage 20. The rate that the target content diffuses or flows to the air flow passage 20, j_{TC-transport} is functionally related to the concentration of the target content in the target solution or the target gas C_{TC} as shown in Equation (1):

j_{TC-transport} ∝C_{TC} (1)

where j_{TC-transport} is the rate that the target content diffuses or flows to the air flow passage 20 through the diffusion or transport structures, and where C_{TC} is the concentration of the target content in the target solution or the target gas.

d) One or more transfer structures 80. The transfer structures 80 are able to transfer the target content into a content called aim content (AC), which is easy to be detected by available sensors that are called aim sensors 120. The transfer structures 80 are able to complete the transfer process with or without the interference of the carrier gas as shown in Equations (2) and (3) below. The transfer structures 80 may be, but are not limited to, catalyst structures like a catalyst layer consisting of platinum etc. The transfer structures 80 are set along and/or on the cross-section of the air flow passage 20 or any site in the air flow passage where most of the target content that diffuses or flows to the air flow passage must pass by closely or pass through closely. The transfer structures 80 can optionally be attached to the diffusion structure 90.

$$\begin{matrix}TC {\to }^{transfer - structure} AC & ( 2 ) \\ TC + CG {\to }^{transfer - structure} AC + anything\_else \_produced & ( 3 )\end{matrix}$$

e) One or more temperature control structures 70 (72 and 74). The temperature control structures 70 can be but are not limited to a temperature controlled heating device(s). The temperature control structure 70 ascertains the temperature of the diffusion or transport structures 90 and neighborhood region under working conditions and can be kept under constant temperature during the test process. They also ascertain the transfer capability of the transfer structures 80. The temperature control structures 70 may be unnecessary for some conditions if the sensor working under constant condition and the capability of the transfer structure is sufficient enough for the target content to be transferred to the aim content. The amount of the aim content generated is functionally related to the amount of target content that diffuses or flows to the air flow passage 20. The temperature control structures 70 may also be integrated with other parts such as the diffusion or transport structures 90, the separate structure 100 and/or the transfer structures 80.

f) One or more aim sensors 120. The aim sensors 120 can be, but are not limited to, carbon dioxide sensors etc. The aim sensors 120 sense the concentration of the aim content in the carrier gas after the carrier gas passes by or passes through the transfer structures 80. The output of the aim sensors is functionally related to the concentration of the target contents in the target solution or the target gas.

g) One or more thermal management structures 110. The thermal management structures are used to control the temperature of the carrier gas after it passes by or passes through the transfer structures 80. It may be a heat exchanger design for part or all of the air flow passage 20. It may be neglected if the temperature of the carrier gas at the location of the aim sensors 120 is suitable for the aim sensors and satisfies the general safety requirements.

In another non-limiting embodiment of the invention, the system can comprise the elements identified in FIG. 1, where the transfer structure 80 is a platinum catalyst layer, and/or the thermal management structure 110 is not present or is not utilized.

The embodiment can use a platinum catalyst layer as an embodiment of the D-type explained above. Some of the differences between this embodiment and the D-type embodiment are listed as follows.

1. The D-type embodiments can use a fuel cell as a sensor, but this embodiment does not. The embodiment has one or more diffusion or transport structures 90. This could be any kind of diffusion media, not only limited to a polymer electrolyte, because it is just used to diffuse or transport the target solution, not any kinds of ions.

2. The embodiments of type-D have an anode and a cathode, where electrochemical reactions occur. This embodiment does not have them. See d) above, which has “one or more transfer structures.” The transfer structure could be a platinum layer in some cases, which is similar to the cathode used in other embodiments. However, it does not input or output any current or voltage. So strictly speaking, this is not an electrode. The process occurring on the transfer structure could be a chemical reaction in some cases, but not an electrochemical reaction at least in the methanol concentration test as shown below.

3. In an electrochemical device like the embodiment of type D, the current and voltage is affected by many circumstances, e.g., temperature, electrode contact area, polymer electrolyte moisture, the circuit electric resistance, flow rate of the fuel and oxidant, the methanol crossover, the electrode poison, electrode structure and other running conditions, which limit its precision. And, due to the characteristics of the polymer electrolyte, the working temperature is limited, normally below 100° C. In this embodiment, this can be avoided by using other kinds of diffusion media or transport structures. In this embodiment, a gas sensor is used to extract the signal, which is maturely developed and with a very high precision based on the working principle of the invention. For example, using a carbon dioxide sensor, based on the two-channel infrared absorption principle, the resolution can be up to 1 ppm or 0.001 vol. %.

4. As explained above, one of the key structures is the c) diffusion structure, which controls the amount of the target content that diffuses to the air flow passage. The amount of target content that diffuses across the diffusion structure is proportionally related to the concentration of the methanol solution in the sample flow passage; then the d) transfer structure transfers this amount of target content into aim content. That is, the target content is transferred into aim content on the surface of the transfer structure. Because the target content amount is very small, using an aim sensor, very high precision can be obtained, by controlling the carrier gas flow rate, and the precision detected can be easily improved to a higher level by increasing the carrier gas flow rate. With the help of the e) temperature control structure, the test sphere can be extended and the precision can be guaranteed.

5. The working principle is universally applied. By changing different types of the diffusion structure and transfer structure, the carrier gas type and flow rate, this sensor embodiment can result in a high precision sensor for many chemical products that are very hard to be detected at present.

### Test on Methanol Solution

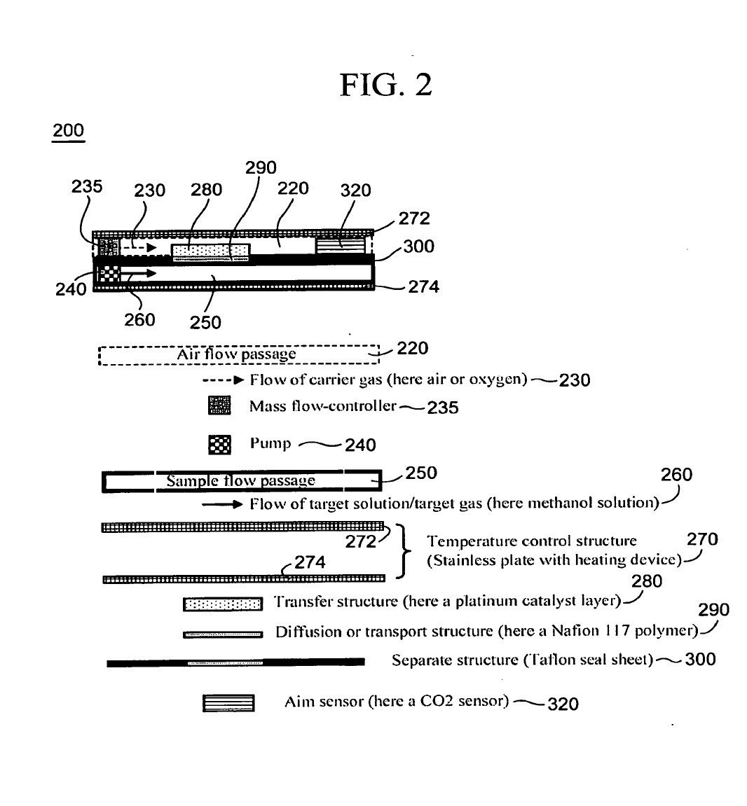

FIG. 2 depicts a test system. In this test, the TC (target content) is methanol, the CG (carrier gas) is air or oxygen, and the AC (aim content) is carbon dioxide. The aim sensor 320 is a carbon dioxide sensor. The mass transport through the diffusion or transport structure 290 is shown in equation 4, and the transfer process occurs on the transfer structure 280 is shown in equation 5.

$$j = - \frac{D Δ c}{t} \qquad ( 4 )$$

Where j—is the mass transport rate of methanol to the air flow passage 220

D—is the effective diffusivity of the diffusion structure 290

t—is the diffusion structure thickness

$${CH}_{3} OH + 1 \frac{1}{2} {O}_{2} \to {CO}_{2} + 2 {H}_{2} O \qquad ( 5 )$$

The air/oxygen flow rate at the air flow passage 220 was controlled and measured by a MKS® mass flow controller 235, and the methanol solution flow rate at the sample flow passage 250 was controlled and measured by a peristaltic pump 240 by Gilson, Inc. The temperature control structure 270 consists of two 316 stainless steel plates (272 and 274) with a heating device to control the working temperature during each experiment. The diffusion structure 290 used was Nafion(® 117 polymer membrane, and the transfer structure 280 was a catalyst layer of Pt-black with a loading of 4 mg cm⁻² and attached to the Nafion® membrane. The active area of the diffusion structure and the transfer structure were both 5 cm^{2 .} The thermal management structure was not necessary (was optional) for this test because the sensor for testing methanol concentration was working under normal temperature, 70° C. When the sensor was working at too high or too low a temperature that the temperature of the output carrier gas was out of the working sphere of the aim sensor, a thermal management structure was added to serve the testing purpose of the aim sensor.

### Results and Discussion

Two groups of experiments were conducted by using air and oxygen correspondingly as the carrier gas, and the concentration of methanol solution ranged from 0.5M to 5M. The air or oxygen flow rate was controlled at 800 sccm. The methanol control flow rate was controlled at 3ml/min.

The results with air as the carrier gas are shown in Graphs 3a and 3b.

TABLE 1
Error analysis on experimental results with air as the carrier gas as shown in Graph 3a: platinum catalyst
layer as the transfer structure; methanol solution(0.5-5M) is used as the target solution, feeding flow
rate, 3 ml/min; air feeding flow rate, 800 sccm; sensor working temperature, 70° C.

| Methanol | | Standard | Standard error | | | | | Number |
|---|---|---|---|---|---|---|---|---|
| Con. (M) | Mean | Deviation | of the mean | Minimum | Maximum | Range | Sum | of Point |
| 0.5M | 9.93E−04 | 7.14E−06 | 4.51E−07 | 9.80E−04 | 0.00101 | 2.92E−05 | 0.2482 | 250 |
| 1M | 0.00203 | 8.34E−06 | 5.27E−07 | 0.00201 | 0.00205 | 3.60E−05 | 0.50782 | 250 |
| 2M | 0.00409 | 1.92E−05 | 1.21E−06 | 0.00404 | 0.00413 | 9.00E−05 | 1.02269 | 250 |
| 3M | 0.00664 | 2.41E−05 | 1.52E−06 | 0.00659 | 0.00675 | 1.61E−04 | 1.65949 | 250 |
| 5M | 0.01168 | 3.80E−05 | 2.40E−06 | 0.0116 | 0.01175 | 1.52E−04 | 2.91917 | 250 |

Graph 3a shows that for different concentrations of methanol input, there is a correspondingly different carbon dioxide concentration output. The higher the methanol concentration is, the higher the carbon dioxide concentration is. The output carbon dioxide concentration does not change much with time, and an enlarged figure for methanol solution of 5M is shown in Graph 3b, and the variation of the tested carbon dioxide concentration with time is stressed. Further error analysis on the data of Graph 3a was conducted, and the results are shown in Table 1, which shows that when the air flow rate is 800 sccm, the standard deviation is3.80×10⁻⁵, the maximum standard error of the mean carbon dioxide concentration is 2.4×104⁻⁶, the corresponding of mean value is 0.1168. Thus, the test is valid and has high precision.

To detect the relationship between the methanol concentration and the corresponding carbon dioxide concentration, the first two lists of Table 1 are used to draw the following Graph 3c.

Graph 3c shows that the carbon dioxide concentration output is linearly related to the concentration of the methanol being tested. R (Correlation Coefficient) is 0.98966, SD (Standard Deviation) is 7.3948×10⁻⁴. From the fitted line, if a value of carbon dioxide concentration is obtained, the concentration of the corresponding methanol solution can be obtained with high precision. From the experimental results, the diffusion coefficient of the Nafion polymer can be obtained by combining the Equation (4) and Equation (6).

$$j = - \frac{D Δ c}{t} \qquad ( 4 )$$

Where D—is the effective diffusivity of the diffusion structure for target content

t—is the diffusion structure thickness (For Nafion®117, t=0.018 mm)

$$\frac{{Con}_{{CO}_{2}} \cdot Flow \text{-} {rate}_{carrier gas} \times 1 E - 3}{60 \times 24.15} = j \cdot A \qquad ( 6 )$$

Where A=5 cm², Carrier gas flow rate is 800 sccm, and —ΔC=Con₍ₘₑₜₕₐₙₒₗ₎

Combining Equation (4) and Equation (6), there is a relationship between the carbon concentration and the methanol concentration as shown in Equation (7).

$${Con}_{( {CO}_{2} )} = \frac{D \cdot A \times E - 4}{t \times E - 3} \cdot \frac{60 \times 24.15}{8} \cdot {Con}_{( methanol )} \times {10}^{3} \qquad ( 7 )$$

Comparing Equation (7 ) and the fit linear equation in Graph 3c, we have Equation (8) and Equation (9):

$$0.00247 = \frac{D \cdot A \times E - 4}{t \times E - 3} \cdot \frac{60 \times 24.15 \times {10}^{3}}{8} \qquad ( 8 )$$

### Yielding:

D=4.909317×10⁻¹⁰ m²/s (9)

The results for the group of experiments with oxygen as the carrier gas are shown in Graphs 4a and 4b.

TABLE 2
Error analysis on the experimental results with oxygen used as the carrier gas as
shown in Graph 4a: platinum catalyst layer as the transfer structure; methanol solution(0.5-5M)
was used as the target solution, feeding flow rate was 3 ml/min; oxygen feeding
flow rate was 800 sccm; sensor working temperature 70° C.

| Methanol | | Standard | Standard error | | | | | Number |
|---|---|---|---|---|---|---|---|---|
| Con. (M) | Mean | Deviation | of the mean | Minimum | Maximum | Range | Sum | of Point |
| 0.5M | 9.82E−04 | 6.38E−06 | 4.03E−07 | 9.70E−04 | 0.000999 | 2.90E−05 | 0.2455 | 250 |
| 1M | 0.00192 | 6.98E−06 | 4.41E−07 | 0.00191 | 0.00194 | 3.50E−05 | 0.48067 | 250 |
| 2M | 0.00376 | 1.26E−05 | 7.99E−07 | 0.00372 | 0.00378 | 5.50E−05 | 0.93912 | 250 |
| 3M | 0.00664 | 2.41E−05 | 1.52E−06 | 0.00659 | 0.00675 | 1.61E−04 | 1.65949 | 250 |
| 5M | 0.01073 | 2.73E−05 | 1.73E−06 | 0.01068 | 0.01081 | 1.24E−04 | 2.68168 | 250 |

Similarly, the relationship between the carbon dioxide concentration and the corresponding methanol concentration was established depending on the data from the first two lines of Table 2. The results and corresponding linear fit line are shown in Graph 4c.

Graphs 4a, 4b and 4c and Table 2 show that when oxygen was used as the carrier gas, the slope of the linear fit was 0.00217, very close to the one obtained with air as the carrier gas, which is 0.00247. Comparing the results obtained with oxygen as the carrier gas, the maximum standard deviation is 2.73×10⁻⁵, the standard error of the mean is 1.73×10⁻⁶, the corresponding mean value is 0.01073; while for the case of using air as the carrier gas, the standard deviation is 3.80×10⁻⁵, the maximum standard error of the mean carbon dioxide concentration is 2.4×10⁻⁶, the corresponding of mean value is 0.1168. Thus, the results obtained with oxygen as the carrier gas are regarded as being of high precision.

Repeating the procedure of calculating the methanol diffusion coefficient from Equations (4)-(9), it yields:

D=4.313043×10⁻¹⁰ m²/s (10)

This is a closer result for the physical methanol diffusion coefficient in Nafion(® at the corresponding working conditions of 70° C.

### Effect of Different Carrier Gases and Methanol Flow Rate on the Test Results

A series of experimental results with different carrier gases (air or oxygen), and different methanol flow rate are shown in the following Graphs.

TABLE 3
Error analysis on experimental results with different carrier gas and methanol flow rate as shown in
Graph 5a: platinum catalyst layer as the transfer structure; methanol solution of 0.5M was used as the
target solution; carrier gas feeding flow rate was 800 sccm; sensor working temperature 70° C.

| | | | standard | | | | | |
|---|---|---|---|---|---|---|---|---|
| methanol | | | deviation | | | | | |
| flowrate- | | standard | of the | | | | | number |
| carrier gas | mean value | deviation | mean value | minimum | maximum | range | sum | of points |
| 0.5-air | 8.95E−04 | 1.00E−05 | 6.35E−07 | 8.72E−04 | 9.11E−04 | 3.86E−05 | 0.22384 | 250 |
| 0.5-oxygen | 8.68E−04 | 3.68E−06 | 2.33E−07 | 8.59E−04 | 8.79E−04 | 1.95E−05 | 0.21696 | 250 |
| 3.0-air | 9.93E−04 | 7.14E−06 | 4.51E−07 | 9.80E−04 | 0.00101 | 2.92E−05 | 0.24820 | 250 |
| 3.0-oxygen | 9.82E−04 | 6.38E−06 | 4.03E−07 | 9.70E−04 | 9.99E−04 | 2.90E−05 | 0.24550 | 250 |

From Graph 5a and Table 3, it shows that when the methanol concentration is as low as 0.5M, the different methanol flow rates, 0.5 ml/min or 1 ml/min, leads to a difference in the test results by about 10%; but the difference of the carrier gases, air or oxygen, dose not affect the test results as much as the methanol flow rate, only within 4%. When the sensor working condition is fixed, for certain types of carrier gas and methanol flow rates, the test results are stable. The maximum standard deviation is 1.00E-5, which occurs when air is used as the carrier gas and methanol flow rate is 0.5 ml/min. The standard deviation is not related with methanol flow rate, but using oxygen as the carrier gas helps to reduce the standard deviation of the test data.

TABLE 4
Error analysis on experimental results with different carrier gas and methanol flow rate as shown in
Graph 5b: platinum catalyst layer as the transfer structure; methanol solution of 1M was used as the
target solution; carrier gas feeding flow rate was 800 sccm; sensor working temperature 70° C.

| | | | standard | | | | | |
|---|---|---|---|---|---|---|---|---|
| methanol | | | deviation | | | | | |
| flowrate- | mean | standard | of the | | | | | number |
| carrier gas | value | deviation | mean value | minimum | maximum | range | sum | of points |
| 0.5-air | 0.0018 | 3.08E−05 | 1.95E−06 | 0.00177 | 0.00186 | 9.60E−05 | 0.45056 | 250 |
| 0.5-oxygen | 0.00171 | 1.91E−05 | 1.21E−06 | 0.00167 | 0.00175 | 7.30E−05 | 0.42871 | 250 |
| 3.0-air | 0.00203 | 8.34E−06 | 5.27E−07 | 0.00201 | 0.00205 | 3.60E−05 | 0.50782 | 250 |
| 3.0-oxygen | 0.00192 | 6.98E−06 | 4.41E−07 | 0.00191 | 0.00194 | 3.50E−05 | 0.48067 | 250 |

From FIG. 5b and Table 4, it shows that when the methanol concentration is 1M, the different methanol flow rate, 0.5 ml/min and 3 ml/min, leads to a difference in the test results by about 10%; but the difference of the carrier gases, air or oxygen, dose not affect the test results much, only around 5%. When the sensor working condition is fixed, i.e., for certain types of carrier gas and methanol flow rate, the test results are stable. The maximum standard deviation is 3.08E-5; it occurs when air is used as the carrier gas and methanol flow rate is 0.5 ml/min. The standard deviation is reduced with higher methanol flow rates, and using oxygen as the carrier gas helps to reduce the standard deviation of the test data.

Experimental results on methanol solution of 2M, 3M and 5M with different methanol flow rates and carrier gases yields similar conclusions, and they are shown in the following Graphs.

In summary, a highly precise multi-purpose high-precision sensor has been invented. It can be used as a high-precision sensor to detect many chemical contents whose detection is usually time consuming and economically costly. The invention is based on the inventive principle that a high-precision sensing procedure of content which is hard to detect (target content) can be obtained by transferring this content into another content (aim content) which is easier to detect. By utilizing the inventive diffusion structure, the amount of the target content that transfers into the aim content can be controlled, and this amount is functionally related to the concentration of the target content in a solution or a mixed gas. A series of experimental tests on methanol solution of 0.5M-5M were conducted, and the validity of the inventive structure and method has been confirmed by the test results.

The embodiments of the invention can be utilized to determine the concentration of many contents in solution or gas mixtures that are difficult to determine with any known technology. The embodiments have high precision, low cost, and rapid response. The embodiments are also be self calibrating.

The embodiments have applicability in the fields of: renewable energy, methanol based energy systems including direct methanol fuel cell (DMFC) portable power generation, DMFC stationary power generation, DMFC clean energy vehicles, DMFC computer batteries, DMFC batteries for military use and for PDAs, cell-phones, etc., ethanol based energy systems, other energy systems, chemical industries, e.g., chemical synthesis, pharmaceutical industry, and the biology industry.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the specification and claims.

What is claimed is:

1. A multi-purpose concentration sensor (MPCS) for compounds or gases for testing the concentration of a target content of the compound or gas, which comprises:
a. two chambers or flow passages,
b. a separate structure,
c. one or more diffusion or transport structures,
d. one or more transfer structures,
e. optionally, one or more temperature control structures,
f. one or more aim sensors, and
g. optionally, one or more thermal management structures.

2. A MPCS according to claim 1, wherein the first of two said chambers or flow passages is for a carrier gas comprising air, oxygen and/or other carrier gases to flow through, and is named “air flow passage,” and the second of two said chambers or flow passages is for a target solution or target gas to flow through or to store the target solution or target gas, and is named “sample flow passage.”

3. A MPCS according to claim 2, wherein said target solution or target gas is fed by a passive method or through an electric-driven device.

4. A MPCS according to claim 3, wherein said electric-driven device is a pump or blower.

5. A MPCS according to claim 2, wherein said carrier gas is fed by an active method or directly from a high-pressure gas source.

6. A MPCS according to claim 5, wherein said active method is a pump or air blower.

7. A MPCS according to claim 5, wherein said high-pressure gas source is a gas tank.

8. A MPCS according to claim 2, wherein at least one device is used for a constant flow rate.

9. A MPCS according to claim 2, wherein said separate structure is set between said sample flow passage and said air flow passage to separate the two passages.

10. A MPCS according to claim 2, wherein said diffusion or transport structures consist of part or all of the separate structure, through which said target content in said sample flow passage is able to diffuse or just flow to said air flow passage, and the rate of said target content diffuses or flows to said air flow passage is functionally related to the concentration of said target content in said target solution or said target gas.

11. A MPCS according to claim 2, wherein said transfer structures are able to transfer the target content into an aim content that is easily detected by aim sensors.

12. A MPCS according to claim 11, wherein said transfer structures are able to complete said transfer with or without the interference of said carrier gas.

13. A MPCS according to claim 12, wherein said transfer structures are set along and/or on the cross-section of said air flow passage or any site in the air flow passage where most of said target content that diffuses or flows to said air flow passage must pass by closely or pass through closely.

14. A MPCS according to claim 13, wherein said transfer structures are attached to said diffusion structure.

15. A MPCS according to claim 12, wherein said transfer structures are catalyst structures.

16. A MPCS according to claim 15, wherein said catalyst structures have a catalyst layer comprising platinum, carbon or other contents.

17. A MPCS according to claim 2, wherein said temperature control structures comprise a temperature controlled heating device.

18. A MPCS according to claim 2, wherein said temperature control structure ascertains the temperature of said diffusion or transport structures and a neighborhood region under working conditions and is kept under constant temperature during the test process.

19. A MPCS according to claim 18, wherein said temperature control structure also ascertains the transfer capability of said transfer structures, and wherein the amount of said target content that diffuses or flows to said air flow passage is functionally related to the amount of said aim content generated, and said temperature control structures are optionally integrated with said diffusion or transport structures, said separate structure and/or said transfer structures.

20. A MPCS according to claim 2, wherein said aim sensors are carbon dioxide sensors.

21. A MPCS according to claim 2, wherein said aim sensors sense the concentration of said aim content in said carrier gas after said carrier gas passes by or passes through said transfer structures, and the output of said aim sensors is functionally related to the concentration of said target contents in said target solution or said target gas.

22. A MPCS according to claim 2, wherein said thermal management structures are used to control the temperature of said carrier gas after it passes by or passes through said transfer structures.

23. A MPCS according to claim 22, wherein said thermal management structures are heat exchangers designed for part or all of said air flow passage, which can be neglected if the temperature of said carrier gas at the location of said aim sensors is suitable for said aim sensors.

24. A method of testing the concentration of a target content of the compound or gas using a MPCS according to claim 1.
